(19) United States
(12) Patent Application Publication
(10) Pub. No.: US 2005/0004988 A1
(43) Pub. Date: Jan. 6, 2005

(54) Method for providing content-neutral control over electronic mail message exchange

(76) Inventor: Damian J. Farry, San Diego, CA (US)

Correspondence Address: JAMES P. LONGFELLOW, ESQ., 12802 SUNNYVALE COURT, OAK HILL, VA, 20171, US

(21) Appl. No.: 10/844,625

(22) Filed: May 13, 2004

Related U.S. Application Data
(60) Provisional application No. 60/484,796, filed on Jul. 3, 2003.

(51) Int. Cl. G06F 15/16

(52) U.S. Cl. 709/206

(57) ABSTRACT

A method for providing content-neutral control over electronic mail message exchange is described. A value assessable on a rejected sending of an email message is assigned. An email message identifying at least one email recipient is received and the assessable value is debited from a potential email sender. Receipt of the email message is controlled. The email message can be accepted by the at least one email recipient and the assessable value refunded to the potential email sender. The email message can be rejected by the at least one email recipient and the assessable value collected from the potential email sender. The assessable value can be reimbursed back to the potential email sender if the email is ignored.

### CROSS-REFERENCE TO RELATED APPLICATION

This non-provisional patent application claims priority under 35 USC § 119(e) to U.S. provisional patent application, Serial No. 60/484,796, filed Jul. 3, 2003, the disclosure of which is incorporated by reference.

### FIELD OF THE INVENTION

The present invention relates in general to electronic mail control and, in particular, to a system and method for providing content-neutral control over electronic mail message exchange.

### BACKGROUND OF THE INVENTION

Networked communications over internetworks, particularly as provided by the Internet, continue to evolve and gain wider acceptance as a general form of communications. In particular, electronic mail, or simply, “email,” has enjoyed increasing popularity, in part due to the widespread adoption of personal computers in homes, workplaces and on an increasing number of mobile computing platforms. In addition, email has also become available on other forms of communication devices, such as Web-enabled cellular telephones, pagers, personal data assistants, and mobile email message devices, such as the Blackberry, licensed by Research In Motion, Waterloo, Ontario, Canada.

Email messages typically consists of written text, but can also include sound and visual information, either embedded or provided as attached content. Routing information is stored in a header prepended to the message body and generally specifies at least a sender, one or more recipients and subject. Email message communications involve three logical groups of components. Email messages are composed and sent from a sending user using an email message client. Incoming email messages are received by a server, often operated by an Internet Service Provider (ISP), and queued for delivery. Outgoing email messages are dispatched from the server to receiving users also using email message clients. Upon email message receipt, at their discretion, each receiving user can list, read, discard, or ignore the email, could reply to the email, or forward or copy the email message to another user.

Generally, internetworks are architected to encourage the free exchange of email between all users. However, there are no restrictions that limit the content of email messages, or, more importantly, the number of email messages sent by a given user. Unfortunately, this same lack of restrictions enables scurrilous users to abuse email. These individuals typically send out email messages in bulk and often conceal their identities using false identification and routing information. The problem continues to worsen as email messages gains increasingly broader acceptance. The problem is particularly frustrating, as the abusers act without fear of reprisal and with an indifference to the costs and inconvenience to other users. Moreover, these same individuals generally fail to respect the social implications attendant to sending morally suspect or offensive content.

One particular class of scurrilous users, so-called “spammers,” includes persons and organizations that send out large numbers of unsolicited email as a matter of routine. The unsolicited email usually advertises products or services in much the same vein as conventional “junk” mail and the sending of these email messages is often for monetary gain or personal motive, such as for evangelical, political and social purposes. As well, the unsolicited email messages are frequently sent to users identified through targeted recipient lists and through Web crawlers that obtain email addresses by parsing posted Web pages.

Three categories of ad hoc solutions attempt to address the growing problem of unsolicited emailings. First, email message filtering attempts to curtail the receipt of unsolicited email messages using a content-dependent approach. A filtering application searches for words and phrases in the subject line and message body indicating that the email message is potentially offensive or otherwise undesired. Suspect messages are generally diverted to a separate mailbox for later review and disposal. However, email message filtering can result in false positives, whereby legitimate email messages are erroneously tagged due to the words and phrases used. Similarly, scurrilous users can easily evade email message filtering by determining the filtered elements and adjusting their email messages accordingly.

Second, email message blocking attempts to intercept incoming email messages using either a blacklist or whitelist. A blacklist identifies the addresses of known scurrilous users, particularly spammers, and a blocking application prevents receipt of email messages from identified users. However, blacklists are extremely ineffective for several reasons. First, new email addresses are easily obtained. Blacklists must also be updated on a regular basis and maintaining blacklists can be time consuming. A whitelist identifies the addresses of only those users from whom email messages will be accepted. Whitelists can be extremely effective, but only if the recipient is willing to strictly limit incoming emails. Whitelists must also be updated on a regular basis and maintaining whitelists can be time consuming.

Third, statistical analysis is similar to email message filtering, but helps reduce the incidence of false positives. Rather than blindly identifying words and phrases, statistical analysis determines the number of occurrences of each word and phrase and analyzes the occurrences within the context of the message. Statistical analysis, though, can result in false negatives and still allow unsolicited email messages to be received. Moreover, scurrilous users can also easily evade statistical analysis by determining the counted elements and adjusting their email messages accordingly

Therefore, there is a need for an approach to controlling email without relying on an evaluation of either routing information or content. Preferably, such an approach would control the exchange of unsolicited and related undesired forms of email messages by providing disincentives to discourage irresponsible emailings.

There is a further need for an approach to providing an email message delivery infrastructure that includes a revenue model akin to postage stamps, but capable of metering email usage to efficiently manage overall email capacity.

### SUMMARY OF THE INVENTION

An embodiment provides a system and method for providing an email message delivery framework. One or more undelivered prepaid email messages received from paying potential email senders are maintained in an aging state pending retrieval by at least one email recipient. Each undelivered prepaid email message is transitioned into one of an accepted state upon acceptance by the at least one email recipient, a rejected state upon rejection by the at least one email recipient, or an expired state upon inactivity by the at least one email recipient.

A further embodiment provides a system and method for providing content-neutral control over electronic mail message exchange. A value assessable on a rejected sending of an email message is assigned. An email message identifying at least one email recipient is received and the assessable value is debited from a potential email sender. Receipt of the email message is controlled. The email message can be accepted by the at least one email recipient and the assessable value refunded to the potential email sender. The email message can be rejected by the at least one email recipient and the assessable value collected from the potential email sender.

Still other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for providing content-neutral control over electronic mail message exchange, in accordance with the present invention.

FIG. 2 is a block diagram showing a system in accordance with a further embodiment of the present invention.

FIG. 3 is a functional block diagram showing a sending client and the first service provider of FIG. 2.

FIG. 4 is a functional block diagram showing a receiving client and the second service provider of FIG. 2.

FIG. 5 is a process flow diagram showing email processing, in accordance with the present invention.

FIG. 6 is a state diagram showing statuses of electronic mail disposition.

FIGS. 7-12 are routing diagrams showing packet processing by the system of FIG. 2.

FIG. 13 is a flow diagram showing a method of providing content-neutral control over electronic mail message exchange, in accordance with the present invention.

FIG. 14 is a flow diagram showing the routine for sending client execution for use in the method of FIG. 13.

FIG. 15 is a flow diagram showing the routine for first service provider execution for use in the method of FIG. 13.

FIG. 16 is a flow diagram showing the routine for second service provider execution for use in the method of FIG. 13.

FIG. 17 is a flow diagram showing the routine for receiving client execution for use in the method of FIG. 13.

### DETAILED DESCRIPTION

System Overview

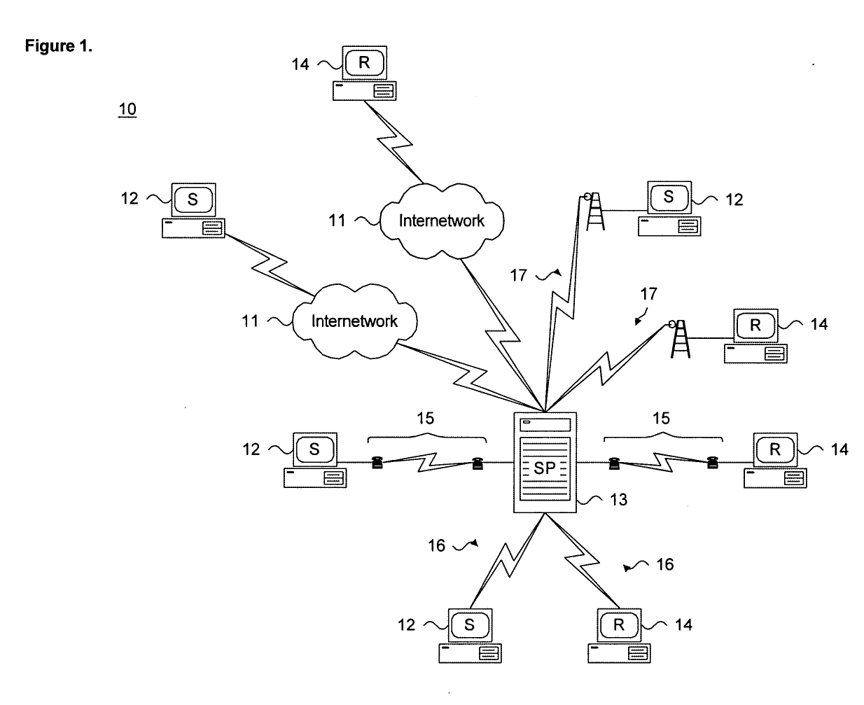

FIG. 1 is a block diagram showing a system 10 for providing content-neutral control over electronic mail message exchange, in accordance with the present invention. A service provider (“SP”) 13 offers network-based services to a plurality of clients, including electronic mail (“email”) service. Email service includes receiving, queuing, forwarding, copying, storing, and dispatching individual email messages amongst individual clients, as is known in the art.

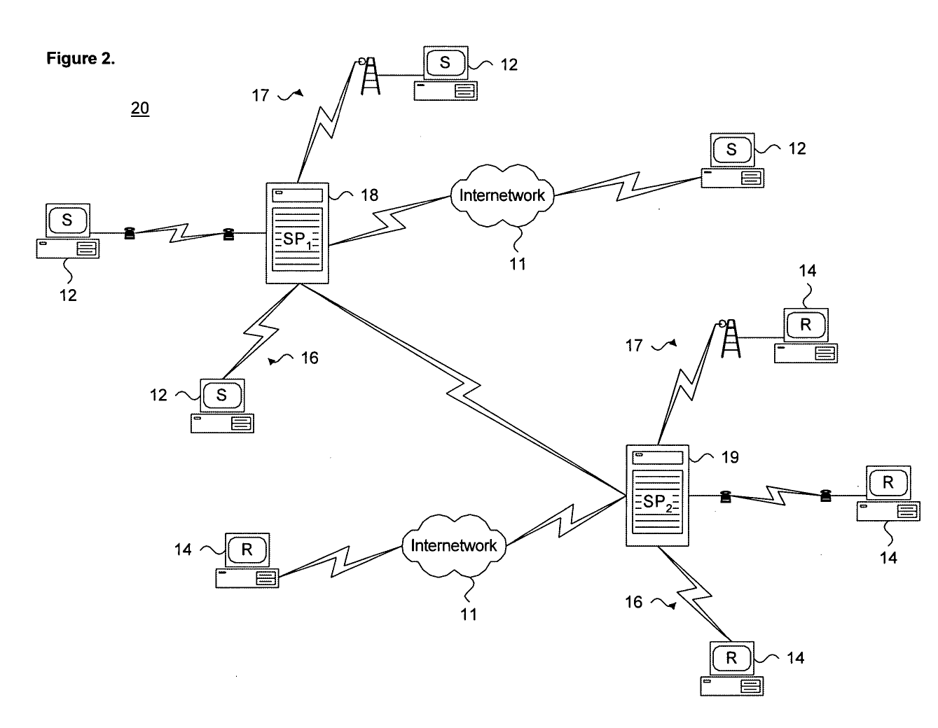

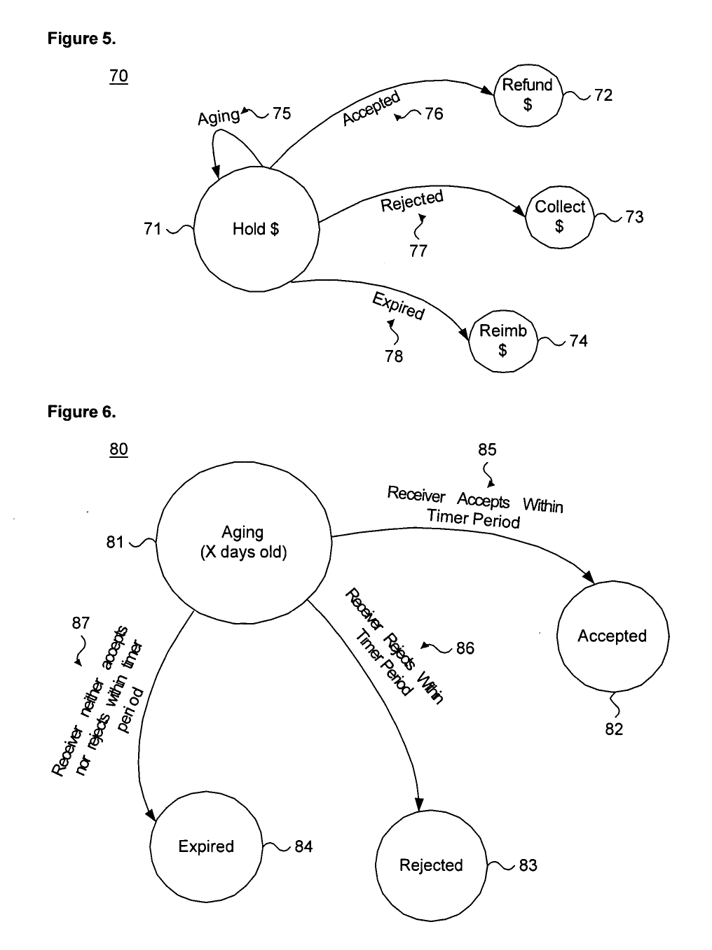

In particular, a plurality of sending clients (“S”) 12 are communicatively interfaced to send email to a plurality of receiving clients (“R”) 14 via the same service provider 13. More commonly, sending clients 12 are communicatively interfaced to receiving clients 14 via a plurality of service providers, as further described below with reference to FIG. 2. Each sending client 12 and receiving client 14 is interfaced to the service provider 13 through one or more communications means, including, by way of example, logically separate segments of an intemetwork 11, dialup connections 15, direct connections 16, and wireless connections 17. Other forms of client/server interconnections are feasible, as would recognized by one skilled in the art. To encourage the free exchange of email, the service provider 13 provides unrestricted email service between all users, but assigns a refundable cost to the delivery of email as a disincentive to irresponsible emailings, as further described below beginning with reference to FIG. 5.

In general, each sending client 12 and receiving client 14 can be any form of computing platform connectable to a network, such as the internetwork 11, and capable of interacting with email application programs. Examples of individual clients include, without limitation, personal desktop and notebook computers, Web-enabled cellular telephones, pagers, personal data assistants, mobile email message devices, such as the Blackberry, licensed by Research In Motion, Waterloo, Ontario, Canada., and various arrangements and configurations thereof, as would be recognized by one skilled in the art. The intemetwork 13 includes various topologies, configurations, and arrangements of network interconnectivity components arranged to interoperatively couple with enterprise, wide area and local area networks and include, without limitation, conventionally wired, wireless, satellite, optical, and equivalent network technologies, as would be recognized by one skilled in the art.

FIG. 2 is a block diagram showing a system 20 in accordance with a further embodiment of the present invention. As above, a plurality of sending clients (“S”) 12 are communicatively interfaced to send email to a plurality of receiving clients (“R”) 14. However, the exchanging of email is respectively coordinated between a sending service provider 18 (“SP1”) and a receiving service provider 19 (“SP2”), which cooperatively transact email service provisioning to each sending client 12 and receiving client 14. In particular, the sending service provider 18 provides email service to sending client 12 and receiving service provider 19 provides email service to receiving client 14, as further described below beginning with reference to FIG. 5. Additional intermediate service providers are feasible, as is known in the art. The system 10 described above with reference to FIG. 1 consolidates the functionality of the sending service provider 18 and receiving service provider 19 in the more commonly implemented system 20 on the single service provider 13. Accordingly, except as otherwise indicated, the remaining discussion will focus on system 20, although one skilled in the art would recognize that the same teachings would apply equally to the system 10.

The individual computer systems, including sending client 12, receiving client 14, and service providers 13, 18 and 19, include general purpose, programmed digital computing devices consisting of a central processing unit (CPU), random access memory (RAM), non-volatile secondary storage, such as a hard drive or CD ROM drive, network or wireless interfaces, and peripheral devices, including user interfacing means, such as a keyboard and display. Program code, including software programs, and data is loaded into the RAM for execution and processing by the CPU and results are generated for display, output, transmittal, or storage.

Sending Client

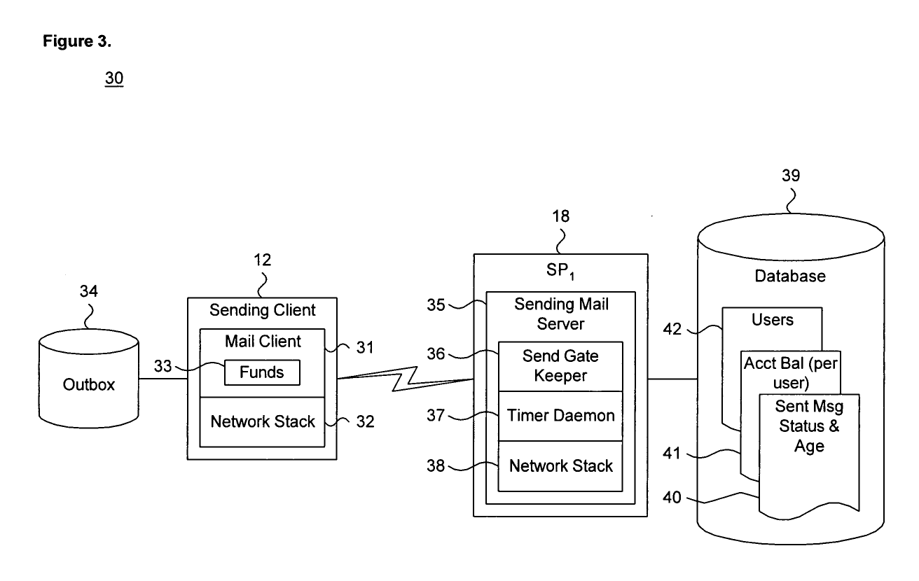

FIG. 3 is a functional block diagram 30 showing a sending client 12 and the sending service provider 18 of FIG. 2. Each sending client 12 executes a mail client 31 for sending email messages to receiving clients 14 via the sending service provider 18. The sending client 12 and sending service provider 18 are logically interfaced via a pair of network stacks 32 and 38, respectively. Outgoing email messages are temporarily stored in an Outbox 34, pending sending to the sending service provider 18. A local funds count 33 for paying for sent emails is stored on the sending client 12.

The sending service provider 18 executes a sending mail server 35, which includes a send gate keeper 36, timer daemon 37 and the network stack 38. The sending service provider 18 maintains a database 39 for storing records containing the statuses and ages of sent messages 40, account balances 41 per user and users 42 authorized to send email messages via the sending service provider 18. Briefly, the sending mail server 35 maintains email accounts for each sending client 12 listed in the user records 42. The send gate keeper 36 restricts email sending to only those users with a sufficient account balance, as indicated in an associated account balance record 41. The send gate keeper 36 also tracks the status of each sent email message. The time daemon 37 tracks the length of time elapsed since the email message was sent, that is, the “age” of each sent email message.

In the described embodiment, the mail client 31 is an application program capable of sending email messages to one or more receiving clients 14 that use the Post Office Protocol (POP), Internet Message Access Protocol (IMAP), or other standard mail client protocol, as is known in the art. The sending mail server 35 receives email messages from mail clients 31 executing on sending clients 12 using the Simple Mail Transfer Protocol (SMTP) or other standard email server protocol, as is known in the art. Preferably, the network stacks 32 and 38 are Transmission Control Protocol/Internet Protocol (TCP/IP) compliant network stacks or other network protocol stacks, as are known in the art.

Receiving Client

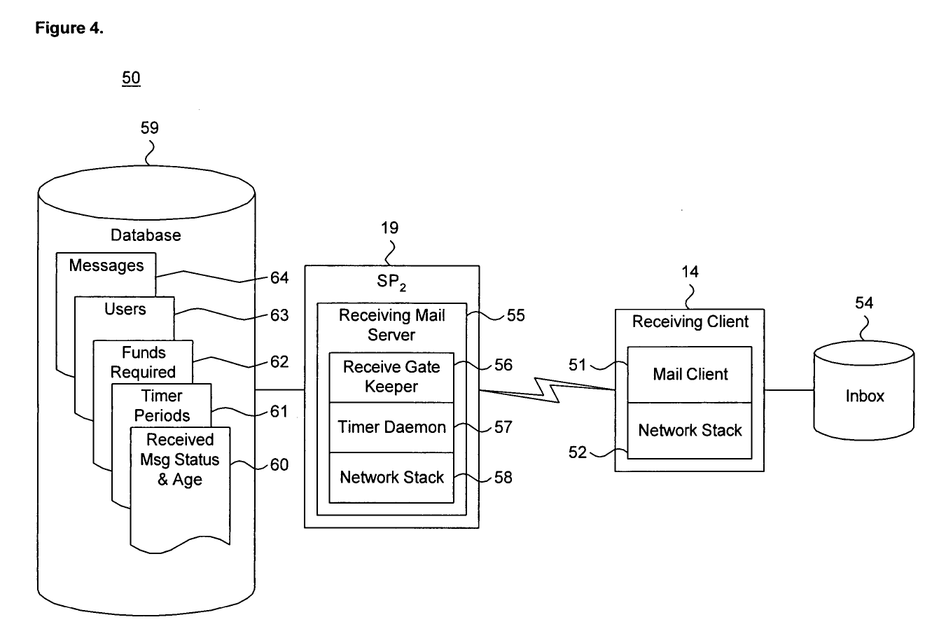

FIG. 4 is a functional block diagram 50 showing a receiving client 14 and the second receiving service provider 19 of FIG. 2. Each receiving client 14 executes a mail client 51 for receiving email messages from sending clients 12 via the receiving service provider 19. The receiving client 14 and receiving service provider 19 are logically interfaced via a pair of network stacks 52 and 58, respectively. Incoming email messages are temporarily stored in the database (not shown), pending retrieval and reading by the user of the mail client 51.

The receiving service provider 19 executes a receiving mail server 55, which includes a receive gate keeper 56, timer daemon 57 and the network stack 58. The receiving service provider 19 maintains a database 59 for storing records containing the statuses and ages of received messages 60, timer periods 61, funds required 62, users 63 authorized to receive email messages via the receiving service provider 19, and incoming messages 64 stored until the receiving client 14 retrieves the messages. Briefly, the receiving mail server 55 maintains email accounts for each receiving client 14 listed in the user records 63. The time daemon 57 tracks the length of time elapsed since the email message was received, that is, the “age” of each received email message.

In the described embodiment, the mail client 51 is an application program capable of receiving email messages from one or more sending clients 12 that use the Simple Mail Transfer Protocol (SMTP) , such as described in R. Orfali et al., “Client/Server Survival Guide,” pp. 407-419, John Wiley & Sons, Inc., New York (3d ed. 1999), the disclosure of which is incorporated by reference, or other standard mail client protocol, as is known in the art. The receiving mail server 55 sends email messages to mail clients 51 executing on receiving clients 14 using the Post Office Protocol (POP), Internet Message Access Protocol (IMAP), or other standard email server protocol, as is known in the art. Preferably, the network stacks 52 and 58 are Transmission Control Protocol/Internet Protocol (TCP/IP) compliant network stacks, such as described in W.R. Stevens, “TCP/IP Illustrated,” Vol. 1, Chs. 1-3, Addison Wesley Longman, Inc., Reading, Mass., (1994), the disclosure of which is incorporated by reference, or other network protocol stacks, as are known in the art.

Process Flow

FIG. 5 is a process flow diagram 70 showing email processing, in accordance with the present invention. Initially, a sending user sends an email to one or more other receiving users using a service provider, such as service provider 13 (shown in FIG. 1) or service providers 18 and 19 (shown in FIG. 2). The sending user must have sufficient funds available to send the email. The funds represent refundable charges that are potentially assessable to sending users as a disincentive to irresponsible emailings. However, to protect legitimate emailings and to encourage unrestricted email service, the charges can be refunded if a receiving user accepts an email or reimbursed, or, alternatively, collected, if the receiving user is tardy in accepting an email. In the described embodiment, the cost to send an email is between 25¢ and 50¢, although other amounts could equally be applied. In addition, different charges can be applied to user-specified classes of sending users, such as lower charges for emails received from friends and families. The refund or reimbursement can be in the form of a refund, collateral, credit, and other forms of repayment, as are known in the art.

Both the email and funds are sent to the service provider and the service provider dispatches the email to each receiving user. The process can then enter one of four states. The first state, holding (State 71), occurs while email receipt is pending. The second and third states, refund (State 72) and collect (State 73), require receiving user action. The last state, reimburse (State 74), occurs due to user inaction. Alternatively, collection can occur as the last state (State 74) due to user inaction. Processing of each email completes upon the occurrence of one of the latter three states.

The four states are connected by state transitions. Upon dispatching the email to each receiving user, the service provider starts a timer and the email begins aging (Transition 75) until the receiving user takes some action. The service provider continues to hold the funds (State 71) while email delivery is pending. If the email is accepted by the receiving user (Transition 76), the service provider refunds the funds to the sending user upon the instructions of the receiving user (State 72). Presumptively, the receiving user approves of the email and agrees that the funds should be refunded to the sending user, who will likely be encouraged to send further emails to the receiving user.

If the email is rejected by the receiving user (Transition 77), the service provider collects the funds from the sending user upon the instructions of the receiving user (State 73). In the described embodiment, the funds are paid to the receiving service provider. Presumptively, the receiving user disapproves of the email, perhaps due to offensive or unwanted content. In this situation, the charges are assessed against the sending user, who will likely be dissuaded from sending further emails to the receiving user. Finally, if the email expires (Transition 78), that is, the timer tracking the length of time that the email has aged has elapsed, the service provider reimburses the funds to the sending user (State 74). Alternatively, the service provider could collect the funds. The charge reimbursement creates a no-cost transaction for the sending user, who is not penalized the cost of sending an unreceived email.

Electronic Mail Disposition

FIG. 6 is a state diagram 80 showing statuses of electronic mail disposition. There are four statuses, aging (Status 81), accepted (Status 82), rejected (Status 83), and expired (Status 84), which respectively correspond to the four state transitions of FIG. 5. All emails start in the aging status (Status 81). The aging status is the only transitory status. All “aging” emails will eventually transition to one of the three other statuses when either accepted or rejected by the receiving user, or until the specified time period has elapsed. In the described embodiment, emails can stay in the aging status no longer than a week, although other time periods could equally be applied.

If the aging email is accepted by the receiving user within the time period (Transition 85), the aging email becomes accepted (Status 82). If the aging email is rejected by the receiving user within the time period (Transition 86), the aging email becomes rejected (Status 83). If the receiving user neither accepts nor rejects the aging email within the time period (Transition 87), the aging email expires (Status 84). Accepted, rejected, and expired are permanent statuses and an email in one of those statuses cannot transition to another state.

Packet Processing

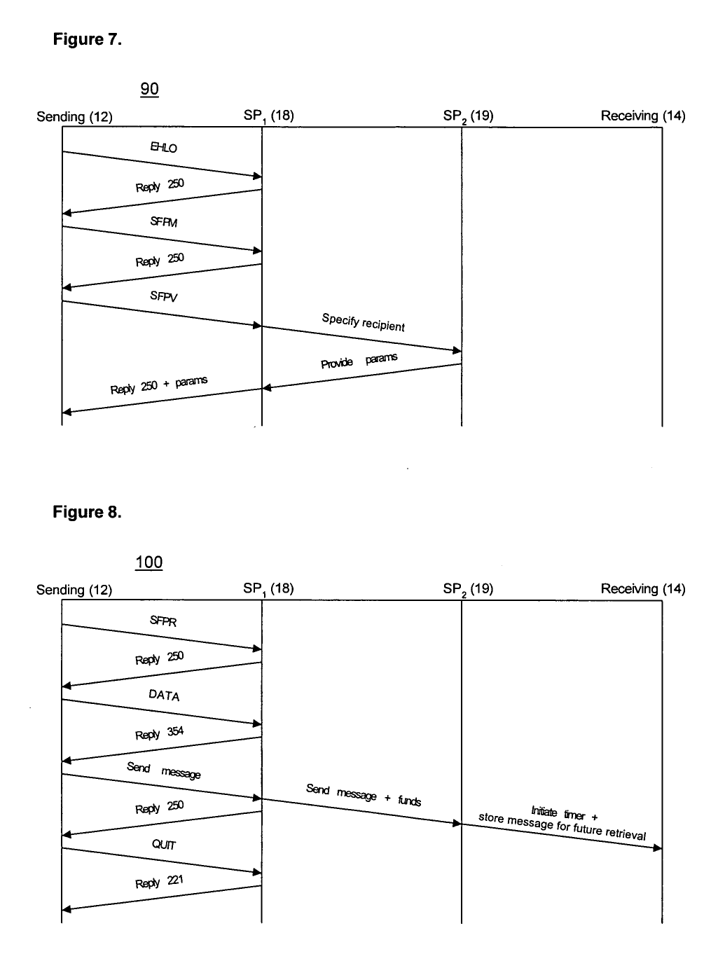

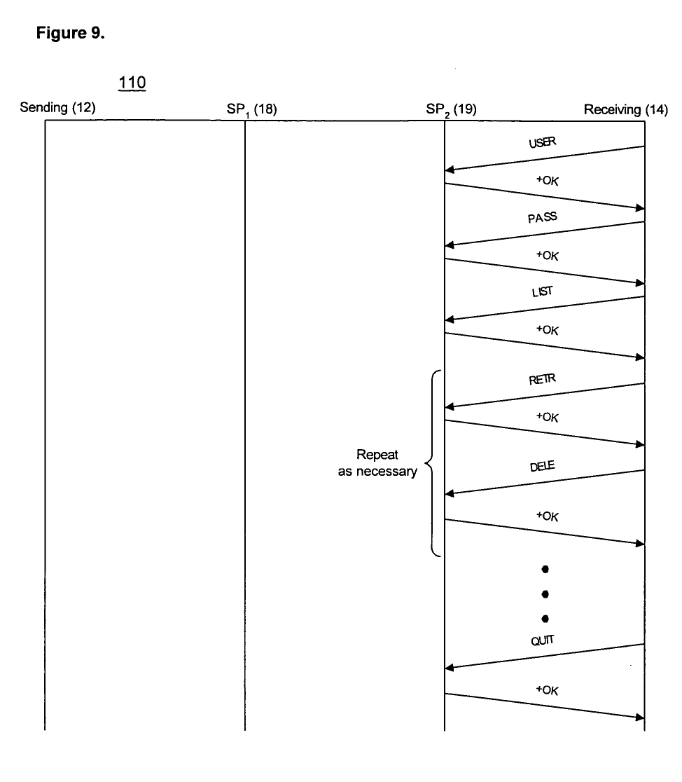

FIGS. 7-12 are routing diagrams showing packet processing by the system of FIG. 2. Briefly, packet processing occurs in two overlapping phases. During the first phase (FIGS. 7 and 8), an email is sent from a sending client 12 to a sending service provider 18 and dispatched to a receiving client 14 via a receiving service provider 19. During the second phase (FIGS. 9-12), the email is either accepted or rejected by the receiving client 14, or the time period expires.

First Phase

During the first phase, the sending client 12 and the sending service provider 18 exchange messages based on an extension to the Simple Mail Transport Protocol (SMTP), as defined in RFC 821 and RFC 822, the disclosures of which are incorporated by reference. In the described embodiment, four additional commands are added: EHLO, SFPM, SFPV, and SFPR, which respectively correspond to the HELO, MAIL, VRFY, and RCPT commands in SMTP.

Email Sending Session Initiation

Referring first to FIG. 7, an email sending session initiation dialogue 90 between the sending client 12 and the sending service provider 18 is shown. The sending client 12 begins by sending an EHLO command to the sending service provider 18 to establish a session for sending email. The EHLO command replaces the HELO command used in SMTP to indicate that additional extended SMTP commands will be used. The sending service provider 18 responds with a reply code 250 (“Requested mail action okay, completed”) to indicate that the sending service provider 18 is ready to receive the email. Next, the sending client 12 sends an SFPM command to the sending service provider 18 with the email address of the sending client 12 as an input parameter. The SFPM command identifies the sending client 12 and indicates that the sending client 12 is sending an email message that requires a potentially assessable charge. In response, the sending service provider 18 verifies the identify of the sending user executing the sending client 12, as indicated in the associated users record 42, and checks that the sending client 12 has sufficient available funds, as indicated in the associated account balance record 41, to send at least one email message. Provided sufficient funds are available, the sending service provider 18 responds with a reply code 250 to indicate the acceptance of the sending client 12. Next, the sending client 12 sends an SFPV command to the sending service provider 18 with the email address of the intended receiving client 14 as an input parameter. The SFPV command requests the sending service provider 18 to obtain email parameters applicable to the receiving client 14. In the described embodiment, the email parameters include a timer period and funds required for email delivery. The sending service provider 18 identifies the intended receiving client 14 to the receiving service provider 19, which provides the email parameters to the sending service provider 18. Finally, the sending service provider 18 responds with a reply code 250 with the email parameters to the sending client 12. By way of example, a response containing email parameters is “250-7-50,” where 250 is the reply code indicating that the receiving client 14 is a valid member of the receiving service provider 19, 7 represents the number of days that will be used for the timer period, and 50 represents the funds required to send an email.

The sending user executing the sending client 12 decides whether to send an email message after examining the email parameters for the receiving client 14. A sending user may decide against sending an email message because the timer period is too long, the funds required are prohibitive, or both. If sending user decides against sending an email message, the sending client 12 sends a RSET command (not shown) to the sending service provider 18 to indicate reset the current transaction without sending an email message and packet processing ends.

Email Message Sending

Otherwise, referring next to FIG. 8, an email message sending dialogue 100 between the sending client 18 and the sending service provider 18 is shown. If the sending user decides to send an email message, the sending client 12 sends an SFPR command to the sending service provider 18 with the email address of the receiving client 14 as an input parameter. The sending service provider 18 responds with a reply code 250 to indicate the acceptance of the receiving client 14 as an intended recipient. In reply, the sending client 12 retrieves the intended email message from the Outbox 34 (shown in FIG. 3) and sends a DATA command to the sending service provider 18 to indicate readiness to start sending the body of the email message. The sending service provider 18 responds with a reply code 354 (“Start mail input; end with <CRLF>.<CRLF>”) to indicate readiness to receive the email message body. The sending client 12 then sends the email message body to the sending service provider 18, using the specified delimiter to indicate that sending client 12 is done, to which the sending service provider 18 responds with a reply code 250 to indicate the acceptance of the email message body. The sending service provider 18 then debits the specified funds from the account of sending client 12, as indicated in the associated account balance record 41, transfers the funds, along with the email message provided by the sending client 12, to the receiving service provider 19 for delivery to the receiving client 14, and records the status and age of the sent email, as indicated in the associated statuses and ages of sent messages record 40. The sending client 12 sends a QUIT command to the sending service provider 18 to indicate session termination. The sending service provider 18 responds with a reply code 221 (“<domain>Service closing transmission channel”) to indicate that the email sending session has terminated.

Second Phase

During the second phase, the receiving client 14 and receiving service provider 19 exchange messages based on an extension to the Post Office Protocol, version 3 (POP3), as defined in RFC 1939, the disclosure of which is incorporated by reference. In the described embodiment, two additional commands are added: SFPA and SFPR, to respectively indicate the acceptance and rejection of the email by the receiving client 14.

Preliminarily, upon receiving each email message from the sending service provider 18, the receiving service provider 19 records the status and age of each received email, as indicated in the associated statuses and ages of received messages record 60, initiates a timer, and stores the received email for future retrieval.

Email Message Retrieval and Deletion

Referring first to FIG. 9, an email message retrieval and deletion session dialogue 110 between the receiving client 14 and the receiving service provider 19 is shown. The receiving client 14 begins by sending a USER command to the receiving service provider 19 with an assigned username as an input parameter. The assigned user name identifies the receiving client 14 to the receiving service provider 19. The receiving service provider 19 responds with an “+OK name is a valid mailbox” message to indicate that the receiving client 14 has been recognized. The receiving client 14 then sends a PASS command to the receiving service provider 19 with an assigned password as an input parameter. The assigned password validates the receiving client 14 to the receiving service provider 19 to establish a session for receiving email. The receiving service provider 19 responds with an “+OK maildrop locked and ready” message to indicate that the receiving client 14 has been validated. The receiving client 14 sends a LIST command to the receiving service provider 19 to request a email message listing, to which the receiving service provider 19 responds with an “+OK scan listing follows” message followed by a listing of email message numbers and sizes. In the described embodiment, the email message listing can be enhanced by displaying the status of each email message, for instance, “accepted,” “rejected,” “expired,” or “aging,” and the date the email message was received by the receiving service provider 19.

The receiving user executing the receiving client 14 can decide whether to retrieve one or more of the email messages. For each email message to be retrieved, the receiving client 14 sends a RETR command to the receiving service provider 19 with a message number as an input parameter to identify the desired email message. The receiving service provider 19 responds with an “+OK message follows” message followed by the email message, including headers. The receiving client 14 stores each retrieved email message in the Inbox 54 (shown in FIG. 4) for later viewing. After successfully retrieving each email message, the receiving client 14 may delete the email message. For each email message to be deleted, the receiving client 14 sends a DELE command to the receiving service provider 19 with a message number as an input parameter to identify the deleted email message. The receiving service provider 19 responds with an “+OK message deleted” message to confirm deletion. In the described embodiment, although an email message may be deleted, the receiving service provider 19 keeps track of the deleted email status for purposes of determining whether a funds reimbursement is owed to the sending client 12. The cycle of email message retrieval and deletion continues until the receiving client 14 sends a QUIT command to the receiving service provider 19 to indicate session termination. The receiving service provider 19 responds with an “+OK” message to indicate session termination. Alternatively, the fund could be collected, rather than reimbursed (not shown).

The cycle of email retrieval and deletion leaves email messages pending receipt for purposes of funds refunds, collections, and reimbursement. Message acceptance and rejection require affirmative actions by the receiving user, while message expiration occurs due to receiving user inaction.

Email Message Acceptance

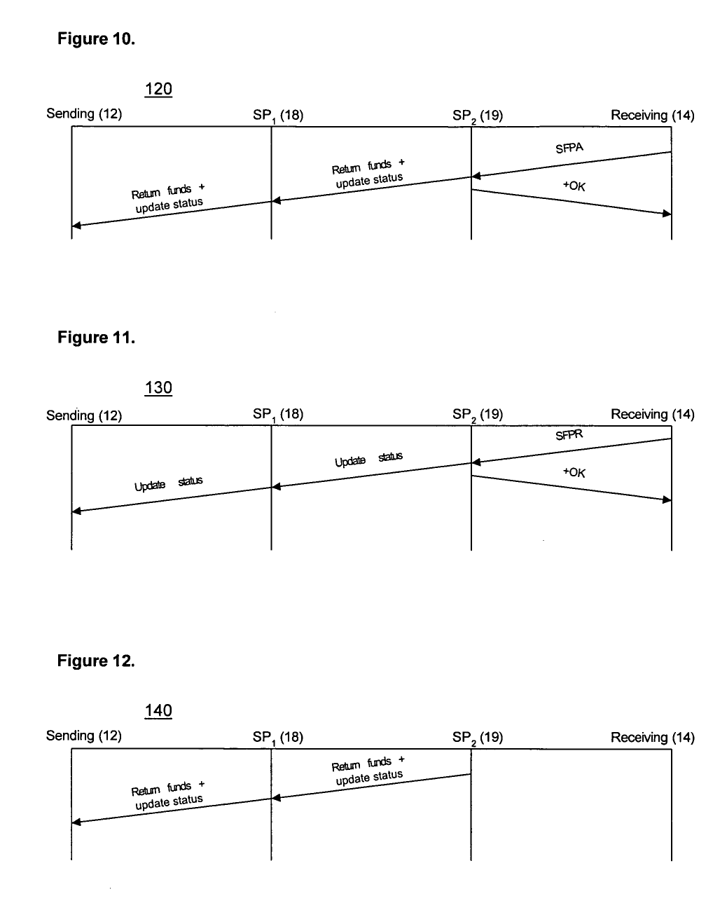

Referring next to FIG. 10, an email message acceptance dialogue 120 is shown. If, after viewing a retrieved email message, the receiving user executing the receiving client 14 accepts the email message, the receiving client 14 sends an SFPA command to the receiving service provider 19 with the message number as an input parameter to indicate email message acceptance. In response, if the identified email message is still in an “aging” status (Status 81), the receiving service provider 19 responds with an “+OK message accepted” message to indicate that the receiving service provider 19 will refund the funds for the identified email message to the sending client 12 via the sending service provider 18. The receiving service provider 19 returns the funds and sends a status message to the sending client 12 via the sending service provider 18. Otherwise, the receiving service provider 19 responds with an “-ERR message already xxx” message, where xxx is “accepted,” “rejected,” or “expired” (not shown).

Email Message Rejection

Referring next to FIG. 11, an email message rejection dialogue 130 is shown. If, after viewing a retrieved email message, the receiving user executing the receiving client 14 rejects the email message, the receiving client 14 sends an SFPR command to the receiving service provider 19 with the message number as an input parameter to indicate message rejection. In response, if the identified email message is still in an “aging” status (Status 81), the receiving service provider 19 responds with an “+OK message rejected” message to indicate that no refund will be made to the sending client 12 and only a status message will be sent to the sending client 12 via the sending service provider 18. Otherwise, the receiving service provider 19 responds with an “-ERR message already xxx” message, where xxx is “accepted,” “rejected,” or “expired” (not shown).

Time Period Expiration

Referring next to FIG. 12, an email message time-out dialogue 140 is shown. The receiving service provider 19 monitors the age of each received email message. Upon the expiration of the time period of a received email message, as indicated in the associated timer period record 61, the receiving service provider 19 returns the funds and sends a status message to the sending client 12 via the sending service provider 18.

Method Overview

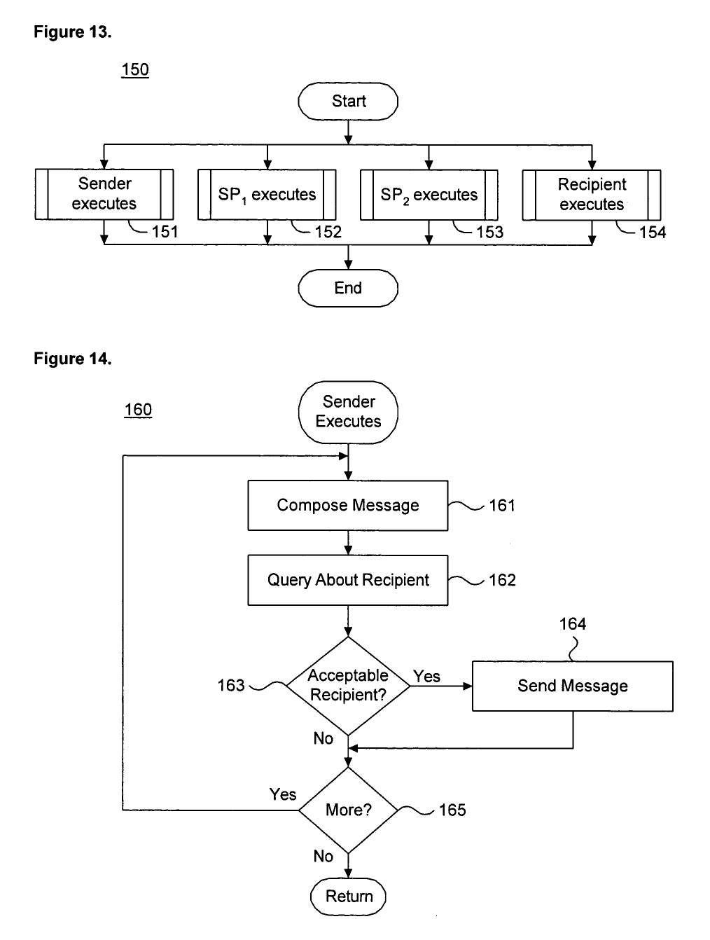

FIG. 13 is a flow diagram showing a method 150 of providing content-neutral control over electronic mail message exchange, in accordance with the present invention. Each component is a computer program, procedure or process written as source code in a conventional programming language, such as the C++ programming language, and is presented for execution by the CPU as object or byte code, as is known in the art. The various implementations of the source code and object and byte codes can be held on a computer-readable storage medium or embodied on a transmission medium in a carrier wave. The method proceeds as four logically separate threads of execution, which are performed by the sending client 12 (block 151), sending service provider 18 (block 152), receiving service provider 19 (block 153), and receiving client 14 (block 154), as further described below respectively with reference to FIGS. 14-17. The method terminates upon the completion of the last execution thread.

Sending Client Execution

FIG. 14 is a flow diagram 160 showing the routine for sending client execution for use in the method 150 of FIG. 13. The purpose of this routine is to transact an email message sending session on a sending client 12.

Initially, a sending user executing the sending client 12 composes an email message (block 161) and sends a query requesting email parameters for the intended email recipient to the sending service provider 18 (block 162). Upon receiving query results, the sending user decides whether the intended email recipient is acceptable (block 163). A sending user may decide that an email recipient is unacceptable because the timer period is too long, the funds required is prohibitive, or both. If acceptable (block 163), the email message is sent (block 164). If the sending user is sending more email messages (block 165), processing continues with composing the next email message (block 161). Otherwise, processing completes and the routine returns.

First Service Provider Execution

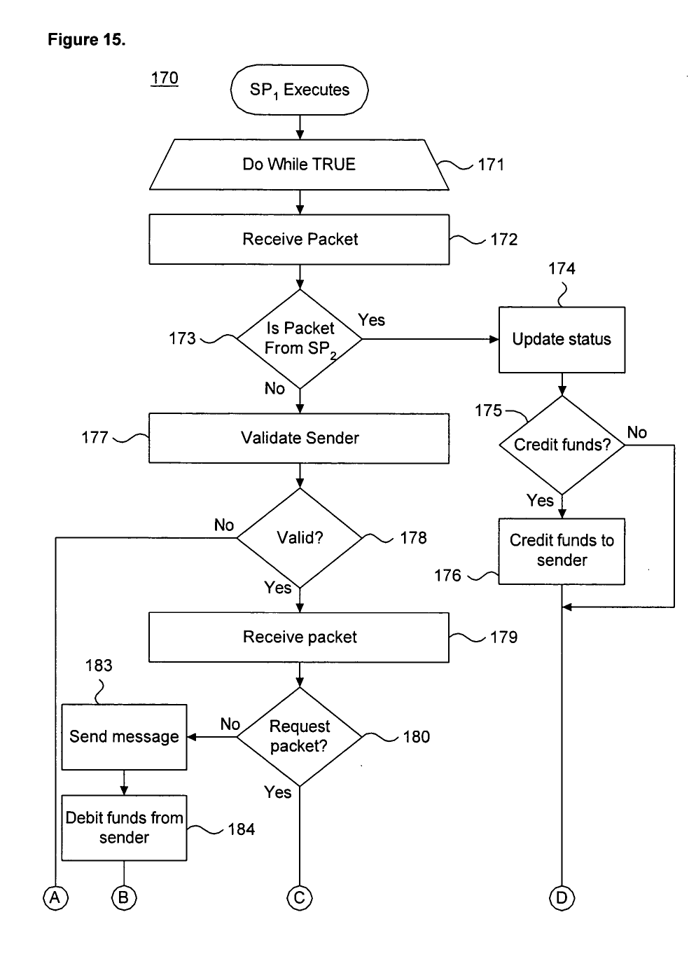

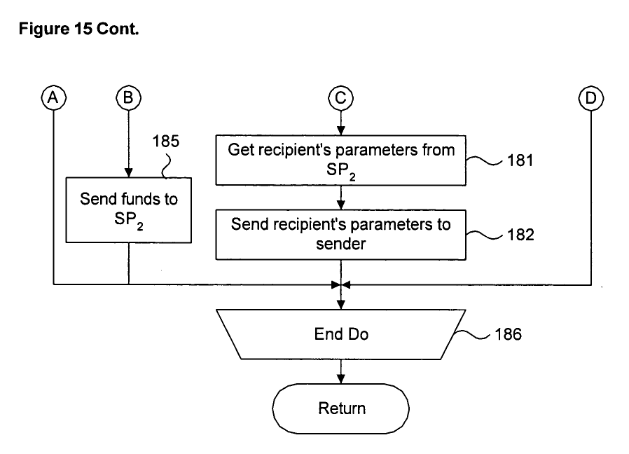

FIG. 15 is a flow diagram 170 showing the routine for first service provider execution for use in the method 150 of FIG. 13. The purpose of this routine is to transact an email message sending session on a sending service provider 18. The routine operates as an iterative processing loop (blocks 171-186). For clarity, only those operations germane to exchanging packets with either a sending client 12 or a receiving service provider 19 are described, although one skilled in the art would recognize that numerous further packet types and operations are feasible.

During each iteration (block 171), a packet is received (block 172) and processed, as follows. If the packet is received from a receiving service provider 19 (block 173), the sending service provider 18 identifies the sent email message to which the packet pertains and updates the sent email message status, as indicated in the associated statuses and ages of sent messages record 40 (block 174). If the packet includes funds to be credited to the sending user who sent the sent email message to which the packet pertains (block 175), the funds are credited to the sending client (block 176). Processing continues with the next packet (block 186).

If the packet is received from a sending client 12, that is, not received from a receiving service provider 19 (block 173), the sending service provider 18 validates the identity of the sending client 12 (block 177). In the described embodiment, the sending service provider 18 verifies the identify of the sending user executing the sending client 12, as indicated in the associated users record 42, and checks that the sending client 12 has sufficient available funds, as indicated in the associated account balance record 41, to send at least one email message. If the sending client 12 is not valid (block 178), processing continues with the next packet (block 186).

Otherwise, if the sending client 12 is valid (block 178), another packet is received from the sending client 12 (block 179). If the packet is a request packet (block 180), the email parameters for an intended email recipient are requested from a receiving service provider 19 (block 181) and sent to the sending client (block 182), after which processing continues with the next packet (block 186). If the packet is not a request packet, that is, the packet contains an outgoing email message (block 180), the email message is sent (block 183) and funds are debited from the sending client 12, as indicated in the associated account balance record 41 (block 184). The funds are sent to the receiving service provider 19 (block 185). Processing continues with the next packet (block 186). The routine returns upon the completion of packet processing.

Second Service Provider Execution

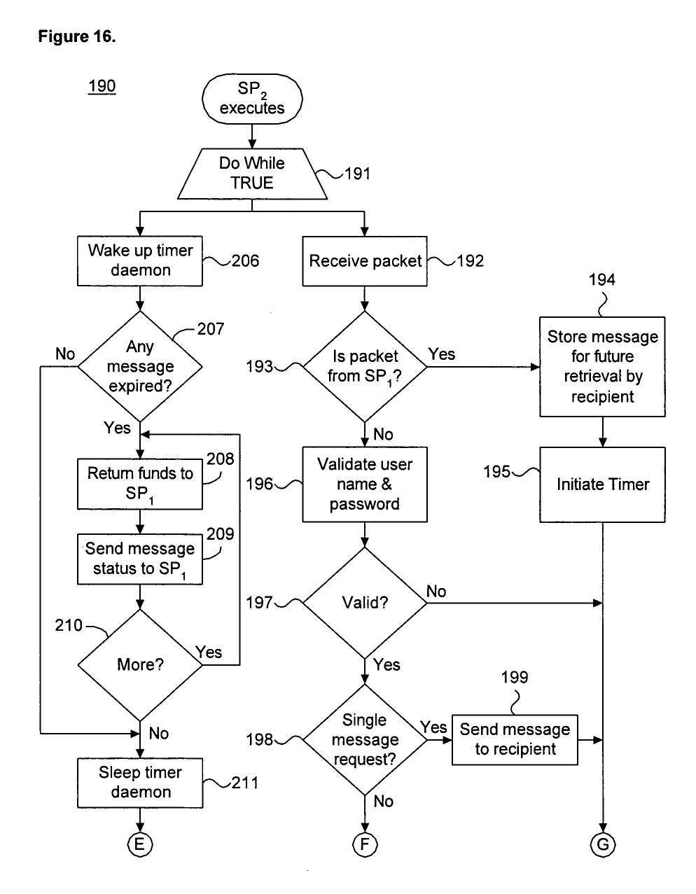

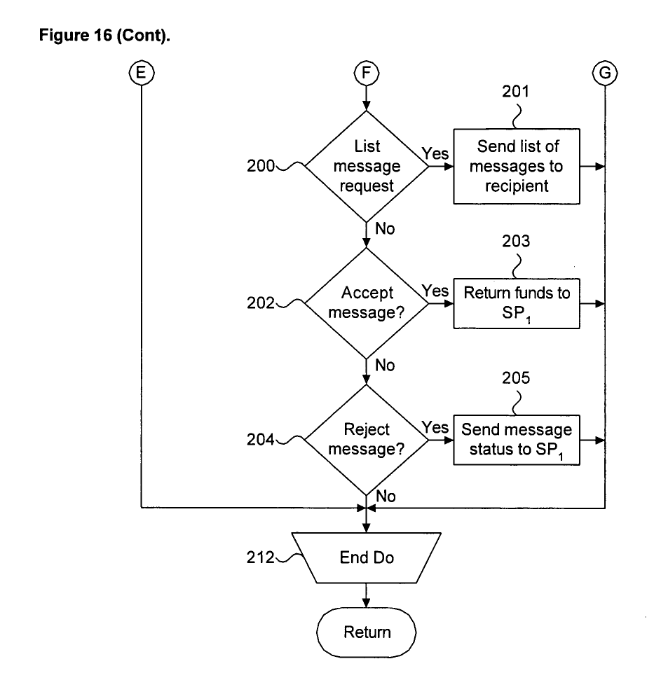

FIG. 16 is a flow diagram 190 showing the routine for second service provider execution for use in the method 150 of FIG. 13. The purpose of this routine is to transact an email message receiving session on a receiving service provider 19. The routine operates as an iterative processing loop (blocks 191-212) with two threads of instruction for receiving packets (blocks 192-205) and timing time periods (blocks 206-211). For clarity, only those operations germane to exchanging packets with either a sending service provider 19 or a receiving client 14 are described, although one skilled in the art would recognize that numerous further packet types and operations are feasible.

During each iteration of the packet receipt thread (block 191), a packet is received (block 192) and processed, as follows. If the packet is received from a sending service provider 18 (block 193), the receiving service provider 19 identifies a received email message to which the packet pertains and stores the received email message for future retrieval by the receiving client 14 (block 194). A timer is initiated for the received email message, as indicated in the timer period record 61 (block 195). Processing continues with the next packet (block 212).

If the packet is received from a receiving client 14, that is, not received from a sending service provider 18 (block 193), the receiving service provider 19 validates the identity of the receiving client 14 (block 196) by assigned username and password. If the receiving client 14 is not valid (block 197), processing continues with the next packet (block 212).

Otherwise, if the receiving client 14 is valid (block 197) and if the receiving client 14 is requesting a single email message (block 198), the email message is retrieved and sent to the receiving client 14 (block 199). Otherwise, if the receiving client 14 is requesting a listing (block 200), an email message listing is generated and sent to the receiving client 14 (block 201). If the receiving client 14 has accepted an email message (block 202), the funds are returned to the sending client 12 (block 203). Similarly, if the receiving client 14 has rejected an email message (block 204), a message is sent to the sending client 12 (block 205) indicated that the funds will not be returned. Processing continues with the next packet (block 212).

During each iteration of the timing time periods thread (block 191), the timer daemon is wakened up (block 206). If any email message has expired (block 207), the funds are returned to the sending client 12 (block 208) and a message is sent to the sending service provider 18 (block 209). The returning for funds and sending of a message are repeated for each expired email message (block 210), after which the timer daemon returns to sleep (block 211). Processing continues with the next packet (block 212). The routine returns upon the completion of packet processing.

Receiving Client Execution

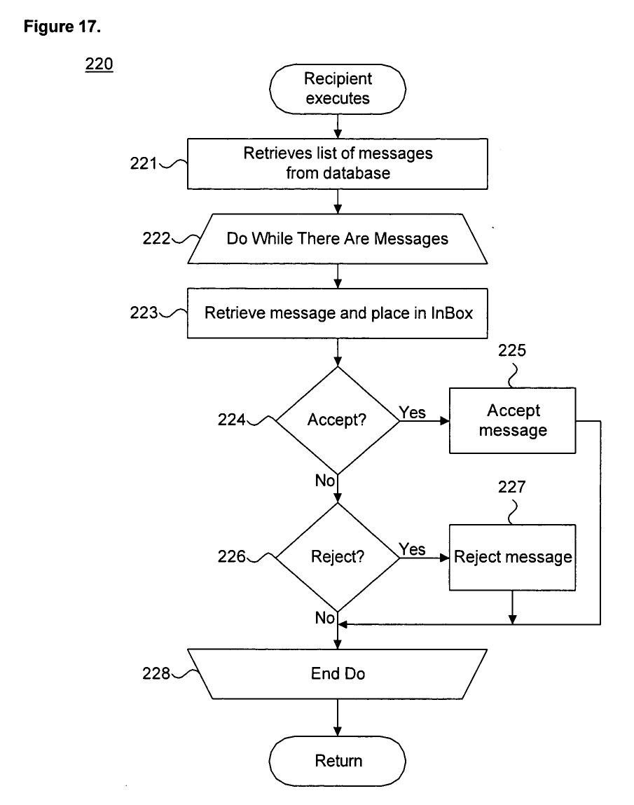

FIG. 17 is a flow diagram 220 showing the routine for receiving client execution for use in the method 150 of FIG. 13. The purpose of this routine is to transact an email message receiving session on a receiving client 14.

Initially, a receiving user executing the receiving client 14 retrieves a list of email messages from the database 59 (block 221). For each email message in the Inbox (block 222), the email message is retrieved and placed in the InBox 54 (block 223). If the receiving user accepts the email message (block 224), the email message is accepted and a refund sent to the sending client 12 via the receiving service provider 19 and sending service provider 18 (block 225). Otherwise, if the receiving user rejects the email message (block 226), the email message is rejected and a message is sent to the sending client 12 via the receiving service provider 19 and sending service provider 18 (block 227). Processing continues with the next email message (block 228). The routine then returns.

While the invention has been particularly shown and described as referenced to the embodiments thereof, those skilled in the art will understand that the foregoing and other changes in form and detail may be made therein without departing from the spirit and scope of the invention.

1. A method for providing content-neutral control over email message exchange, comprising:
assigning a value assessable on a rejected sending of an email message;
determining whether the assessable value is available from a potential email sender;
receiving an email message identifying at least one email recipient and debiting the assessable value from the potential email sender;
assigning a timer value commencing upon receipt of the email message;
running the timer value upon the receipt of the email message from the potential email sender; and
controlling receipt of the email message, comprising one of:
accepting the email message by the at least one email recipient and refunding the assessable value to the potential email sender;
rejecting the email message by the at least one email recipient and collecting the assessable value from the potential email sender; and
upon an expiration of the timer value, expiring the email message and reimbursing the assessable value to the potential email sender;
wherein the assessable value is provided to the potential email sender as one of a refund, collateral and credit;
further wherein the assessable value is assigned by the at least one email recipient;
further wherein the timer value is assigned by the at least one email recipient;
further wherein the email message is communicated between the potential email sender and the at least one email recipient in accordance with Post Office Protocol 3 (POP3);
further wherein the Post Office Protocol 3 (POP3) includes a command SFPA indicating acceptance of the email message by the at least one email recipient and a command SFPR indicating rejection of the email message by the at least one email recipient.
